(19) United States
(12) Patent Application Publication
(10) Pub. No.: US 2017/0195541 A1
(43) Pub. Date: Jul. 6, 2017

(54) VIDEO RECORDING DEVICE

(71) Applicant: OCLU LLC, Tempe, AZ (US)

(72) Inventors: FIRAS KITTANEH, TEMPE, AZ (US); HUGO MARTIN, Oxfordshire (GB); Gregory Dean Hall, Johannesburg (ZA)

(73) Assignee: OCLU LLC., TEMPE, AZ (US)

(21) Appl. No.: 15/084,271

(22) Filed: Mar. 29, 2016

(30) Foreign Application Priority Data
Jan. 5, 2016 (GB) 1600169.5

(51) Int. Cl. H04N 5/232; H04N 5/77; G06F 3/02; H04N 5/225

(52) U.S. Cl. CPC H04N 5/23203; H04N 5/23245; H04N 5/2252; H04N 5/77; G06F 3/02

(57) ABSTRACT

The present invention provides a video recording device comprising
a housing;
a camera unit mounted in the housing and operable to receive an optical input and to output a video data stream relating to a received optical input;
a user input means arranged to be operable by a user of the system, and operable to provide user input signals for the system;
a data storage unit mounted in the housing and operable to store data therein;
a processing unit mounted in the housing and operable to receive a video data stream from the camera unit, to receive user input signals from the user input means, and to control data storage in the data storage unit;
an audio output unit operable to receive a control signal from the processing unit and to output an audio signal to a user in dependence upon such a received control signal,
   wherein the processing unit has a plurality of modes of operation, and is operable to switch from a current mode of operation to a next mode of operation in dependence upon receipt of a user input signal from the user input means, and to output a control signal indicative of the next mode of operation to the audio output unit, the audio output unit being operable to output an audio signal indicative of the next mode of operation upon receipt of such a control signal from the processing unit.

The present invention relates to a multi-mode video recording device with an audio output corresponding to a switching between modes of operation.

Multimode video recording devices are popular as they allow a user to have multiple pre-set mode-types allowing different types of recording, such as simple video recording, time lapse shooting, video loop recording, single photo recording, multi-photo recording, and the like. In addition, the mode-types may have parameters that are either default factory settings or are customizable. Such parameters or settings may include video speed (frames per second), resolution, GPS on/off, duration timers, loop duration, and the like.

Switching between modes is obviously necessary when the user wishes to change the mode-type (e.g. changing between simple video recording or single photo recording) or when the user wishes to change between different versions of the same mode-type (e.g. where the mode-type is the same but parameter settings are different).

Typically, when switching between modes, a user would consult a visible display on the video recording device to determine which mode they have just switched to. However, there are occasions when this is not practical. For example, where the video recording device is an action camera, the camera is often housed within a protective casing and mounted on the clothing or equipment of the user during the filming process. Thus, the protective casing may obscure the camera display and/or the location where the camera is mounted may result in the display not being accessible to the user. To overcome these problems, the user would have to disengage the camera from the mount and/or remove the camera from the protective casing, each time they wished to switch between modes. This is clearly not practical, especially when filming action videos.

Further, the display may be omitted from a camera entirely. This would allow the camera to be smaller in size, which is obviously desirable in the case of action cameras as a camera of reduced size and weight is more easily mounted in place and adds less weight to the user whilst undertaking activity during the filming process. Cameras that omit housing-based displays may use digital mobile applications or PC web-based user interfaces to allow the user to interact with the camera settings. However, it is inconvenient for a user to have to access the mobile app when using the camera each time they wish to change the camera's mode of operation, particularly when using an action camera during the activity being filmed.

Thus, there is clearly a need for an improved video recording device with increase ease of use when changing between modes of operation, and the like.

The present invention seeks to address the problems of the prior art.

Accordingly, a first aspect of the present invention provides a video recording device comprising:
a housing;
a camera unit mounted in the housing and operable to receive an optical input and to output a video data stream relating to a received optical input;
a user input means arranged to be operable by a user of the system, and operable to provide user input signals for the system;
a data storage unit mounted in the housing and operable to store data therein;
a processing unit mounted in the housing and operable to receive a video data stream from the camera unit, to receive user input signals from the user input means, and to control data storage in the data storage unit;
an audio output unit operable to receive a control signal from the processing unit and to output an audio signal to a user in dependence upon such a received control signal,
   wherein the processing unit has a plurality of modes of operation, and is operable to switch from a current mode of operation to a next mode of operation in dependence upon receipt of a user input signal from the user input means, and to output a control signal indicative of the next mode of operation to the audio output unit, the audio output unit being operable to output an audio signal indicative of the next mode of operation upon receipt of such a control signal from the processing unit.

Thus a user can identify the mode of operation to which they have switched based on the recognisable audio signal associated with each mode. The audio signal may be any suitable sound or combination of sounds provided that each audio signal is distinguishable from the others i.e. that each mode has its own unique audio signal that is recognisable by a user over each of the other audio signals.

Modes of operation includes different mode types including, but not limited to simple video recording, time lapse recording, video loop recording, single photo recording, multi-photo recording, and the like. Mode of operation also include different versions of the same mode-type having different parameters. Parameters including, but are not limited to resolution settings, GPS on/off settings, video speed (e.g. frames per second (fps)), duration timers, loop duration and the like.

In one embodiment, the processing unit is operable to cycle through the plurality of modes of operation upon receipt of multiple user input signals from the user input means.

Preferably, the user input means comprises a single button. Alternatively, the user input may comprise a toggle, switch or touch-sensitive pad.

In one embodiment, the user input means comprises a remote control device separate from the housing unit. For example, the user input means may comprise a mobile handset equipped with a mobile application. Alternatively, the user input means may comprise a remote control button, for example, in blue-tooth communication with the video recording device. This is particularly advantageous when the video recording device is an action camera mounted in a position difficult for a user to reach during the activity being undertaken. For example, when surfing, the camera may be mounted on the surf board out of reach of the user when the user is surfing upright. Thus, a remote control button on a wrist-band or the like would be more convenient for operation by a user whilst on the water.

The audio output unit may be located in the housing. Alternatively, the audio output unit may be located separately from the housing, for example in a head set or earpiece. Such a headset or earpiece may be in wireless communication with the video recording device, for example, using Bluetooth or alternative means of wireless communication.

An embodiment of the present invention will now be described, by way of example only, and with reference to the following figures, in which:

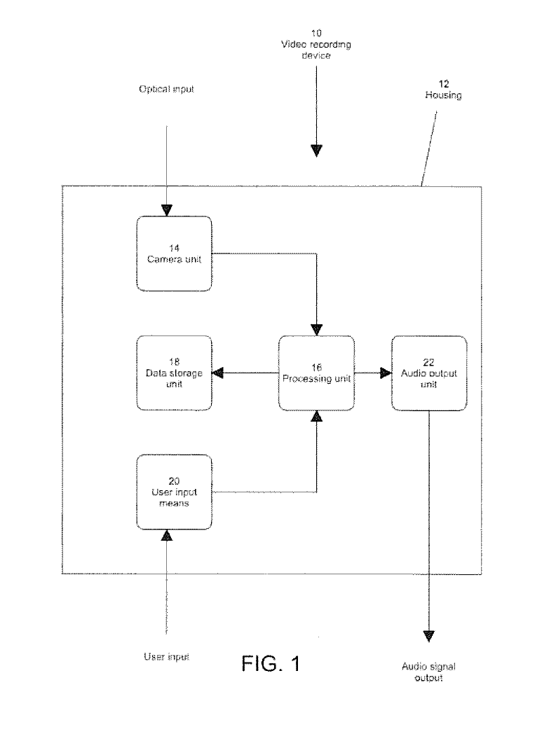

FIG. 1 is a diagrammatic representation of an embodiment of a video recording device in accordance with the present invention.

FIG. 1 shows a video recording device 10 comprising a housing 12 containing a camera unit 14, a processing unit 16, a data storage unit 18, a user input means 20 and an audio output unit 22.

Camera unit 14 is operable to receive an optical input and to output a corresponding video data stream relating to the received optical input. The camera unit 14 is in electrical communication with processing unit 14 and operable to transmit the video data stream to processing unit 14.

On receipt of video data stream from camera unit 14, processing unit 14 is operable to control the storage of received video data in data storage unit 18.

User input means 20 is provided to receive user input signals from a user. For example, the user input means 20 may comprise a button or toggle switch or touch screen user interface provided on housing 12 and acts as a user interface for video recording device 10.

User input means 20 is in electric communication with processing unit 16 and, on receipt of a user input, is operable to transmit a user input signal corresponding to the user input to processing unit 16.

Processing unit 16 has a plurality of modes of operation which may be selected by a user, via user input means 20, when using video recording device 10 to record video footage.

When a user wishes to switch between modes, the user provides a corresponding input to user input means 20. The user interface with video recording device 10 may comprise a button or toggle or switch or may comprise a touch screen display. On provision of an input signal, user input means 20 transmits a corresponding user input signal to processing unit 16.

Processing unit 16 is in electrical communication with audio output unit 22 and, on receipt of the user input signal from user input means 20, is operable to transmit a control signal indicative of the next mode of operation to audio output unit 22. On receipt of the control signal, audio output unit 22 is operable to output an audio signal indicative of the next mode of operation.

As each mode of operation has its own unique audio signal, a user can identify which mode of operation that they have just switched to from the sound emitted by the audio output unit.

The audio signals can be any suitable sound or combination of sounds provided that each mode of operation has a unique audio signal.

Thus, a user will be able to identify which mode of operation they have switched to without having to refer to the video recording device display. This may be particularly convenient when the display of the video recording device 10 is not easily viewed by the user, during user. For example, where the video recording device 10 is an action camera, it may be mounted on the person of the user e.g. on their chest or on a helmet or the like and thus the camera display would not be visible to the user without first disengaging the camera from their clothing or equipment. This is clearly inconvenient every time the user wishes to switch to another mode of operation. However, the provision of an accessible user input means e.g. button, switch or the like, provided on the outside of the camera housing can easily be operated by a user without disengaging the camera from their clothing or equipment and the emitted audio signal will inform the user of the mode they have just switched the camera to.

Although FIG. 1 shows the audio output unit 22 housed within housing 12 of video recording device 10, it will be appreciated that the audio output unit 22 may be external to the housing. For example, the audio signal may be output through a wireless headset worn by the user. Bluetooth enabled headsets are well known. This is particularly advantageous when the video recording device 10 is an action camera. Thus a user will still be able to hear the audio signal resulting from a manually operated switching of modes of operation, even in a noisy environment.

As action cameras are often used in such environments, the ability to be able to hear the audio signal via a headset or earpiece is clearly advantageous.

1. A video recording device comprising
a housing;
a camera unit mounted in the housing and operable to receive an optical input and to output a video data stream relating to a received optical input;
a user input means arranged to be operable by a user of the system, and operable to provide user input signals for the system;
a data storage unit mounted in the housing and operable to store data therein;
a processing unit mounted in the housing and operable to receive a video data stream from the camera unit, to receive user input signals from the user input means, and to control data storage in the data storage unit;
an audio output unit operable to receive a control signal from the processing unit and to output an audio signal to a user in dependence upon such a received control signal,
wherein the processing unit has a plurality of modes of operation, and is operable to switch from a current mode of operation to a next mode of operation in dependence upon receipt of a user input signal from the user input means, and to output a control signal indicative of the next mode of operation to the audio output unit, the audio output unit being operable to output an audio signal indicative of the next mode of operation upon receipt of such a control signal from the processing unit.

2. A device as claimed in claim 1, wherein the processing unit is operable to cycle through the plurality of modes of operation upon receipt of multiple user input signals from the user input means.

3. A device as claimed in claim 1 or 2, wherein the user input means comprises a single button.

4. A device as claimed in claim 1 or 2, wherein the user input means comprises a remote control device separate from the housing unit.

5. A device as claimed in any one of the preceding claims, wherein the audio output unit is located in the housing.

6. A device as claimed in any one of claims 1 to 4, wherein the audio output unit is located separately from the housing.
